(19) United States
(12) Patent Application Publication
(10) Pub. No.: US 2010/0036058 A1
(43) Pub. Date: Feb. 11, 2010

(54) PROPYLENE BLOCK COPOLYMER

(75) Inventor: Yasuki Fujiwara, Chiba (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 12/513,875

(22) PCT Filed: Dec. 14, 2007
(86) PCT No.: PCT/JP2007/074600

§ 371 Date: May 28, 2009

(30) Foreign Application Priority Data
Dec. 15, 2006 (JP) 2006-338995

(51) Int. Cl. C08F 255/00

(52) U.S. Cl. 525/240

(57) ABSTRACT

A propylene block copolymer comprising 60 to 85% by weight of a propylene polymer component and 15 to 40% by weight of an ethylene-propylene copolymer component, and satisfying the following requirements (I) to (V): (I) the above propylene polymer component has a melting temperature of 160° C. or higher measured according to DSC; (II) the above ethylene-propylene copolymer component has an ethylene content of 40 to 60% by weight measured according to a ¹³C-NMR spectrum; (III) the above ethylene-propylene copolymer component has a crystallization peak between 90 to 105° C. in its DSC measurement, and the above crystallization peak is 2 to 10 J in its heat of crystallization, per 1 g of the above ethylene-propylene copolymer component; (IV) the above ethylene-propylene copolymer component has a glass transition temperature of −50° C. or lower measured according to DSC; and (V) the above ethylene-propylene copolymer component has an ethylene-propylene binding moiety, and the ethylene-propylene binding moiety has an intensity ratio of a racemic peak to a meso peak of 0.01 to 0.7 measured according to a ¹³C-NMR spectrum.

### TECHNICAL FIELD

The present invention relates to a propylene block copolymer. For more detail, the present invention relates to a propylene block copolymer, whose molded article is excellent in its stiffness, hardness and moldability, and is also excellent in a balance between its toughness and low-temperature impact resistance.

### BACKGROUND ART

There is referred to as a “propylene block copolymer” a polymer material comprising a crystalline homopolypropylene part or a crystalline random copolymer part, and a non-crystalline rubber part, wherein the crystalline random copolymer part is a copolymer of propylene with a small amount of other olefin than propylene, and the non-crystalline rubber part is a copolymer of ethylene, propylene and an optional other olefin than ethylene and propylene. Such a propylene block copolymer is excellent in its property such as stiffness and impact resistance, and is widely used for molded articles such as automobile interior or exterior parts, electrical parts and cases.

A propylene block copolymer has been highly improved in its performance, focusing on its rubber part structure.

For example, EP 0534776A discloses a propylene-ethylene block copolymer, whose propylene-ethylene random copolymer part contains ethylene in an amount of 20 to 60% by weight, the copolymer part having an intrinsic viscosity of 3.5 to 8.5 dl/g, and the copolymer phase being 5 to 20% by weight of the total of the polymer.

U.S. Pat. No. 5,134,209 discloses a propylene-ethylene block copolymer having a highly irregular copolymerizability in its ethylene-propylene copolymer part (patent literature 2).

However, those conventional propylene block copolymers are not necessarily sufficient in their stiffness and impact resistance, particularly in their low-temperature impact resistance, and further improvement thereof have been desired.

An object of the present invention is to provide a propylene block copolymer excellent in its stiffness and impact resistance, particularly in its low-temperature impact resistance.

From one point of view, the present invention is a propylene block copolymer comprising 60 to 85% by weight of a propylene polymer component and 15 to 40% by weight of an ethylene-propylene copolymer component, and satisfying the following requirements (I) to (V):

(I) the above propylene polymer component has a melting temperature of 160° C. or higher measured according to DSC;

(II) the above ethylene-propylene copolymer component has an ethylene content of 40 to 60% by weight measured according to a ¹³C-NMR spectrum;

(III) the above ethylene-propylene copolymer component has a crystallization peak between 90 to 105° C. in its DSC measurement, and the above crystallization peak is 2 to 10 J in its heat of crystallization, per 1 g of the above ethylene-propylene copolymer component;

(IV) the above ethylene-propylene copolymer component has a glass transition temperature of −50° C. or lower measured according to DSC; and

(V) the above ethylene-propylene copolymer component has an ethylene-propylene binding moiety, and the ethylene-propylene binding moiety has an intensity ratio of a racemic peak to a meso peak of 0.01 to 0.7 measured according to a ¹³C-NMR spectrum.

### BEST MODE FOR CARRYING OUT THE INVENTION

### (I) Propylene Polymer Component

A propylene polymer component, which is one of essential components in the propylene block copolymer of the present invention, is a propylene homopolymer, or a propylene copolymer obtained by copolymerizing propylene with one or more olefins selected from the group consisting of ethylene and α-olefins having 4 to 18 carbon atoms, and has a melting temperature (Tm) of 160° C. or higher measured according to differential scanning calorimetry (DSC). The Tm of the propylene polymer component is preferably 160 to 170° C.

The above propylene copolymer component may be a random copolymer or a block copolymer.

The above propylene copolymer contains preferably 10% by mol or less of one or more olefins selected from the group consisting of ethylene and α-olefins having 4 to 18 carbon atoms.

Examples of the α-olefin having 4 to 18 carbon atoms constituting the above propylene copolymer are 1-butene, 1-pentene, 1-hexene, 1-heptene, 1-octene, 4-methyl-1-pentene, vinylcyclohexane and vinylnorbornane.

The propylene polymer component has a melt flow rate (MFR) of preferably 0.1 to 500 g/10 minutes, and more preferably 0.3 to 300 g/10 minutes, measured at 230° C. under a load of 21 N according to JIS K7210.

The propylene polymer component has an intrinsic viscosity ([η]) of preferably 0.5 to 10 dl/g, and more preferably 0.6 to 2 dl/g.

### (II) Ethylene-Propylene Copolymer Component

An ethylene-propylene copolymer component, which is one of essential components in the propylene block copolymer of the present invention, has an ethylene content of 40 to 60% by weight measured according to a ¹³C nuclear magnetic resonance (¹³C-NMR) spectrum. When the ethylene content is smaller than 40% by weight, the propylene block copolymer of the present invention may be insufficient in its stiffness, because of high compatibility of the ethylene-propylene copolymer component with the propylene polymer component. When the ethylene content is larger than 60% by weight, the propylene block copolymer of the present invention may be insufficient in its impact resistance, because of insufficient compatibility of the ethylene-propylene copolymer component with the propylene polymer component.

The above ethylene-propylene copolymer component has a crystallization peak between 90 to 105° C. in its DSC measurement, and the above crystallization peak is 2 to 10 J in its heat of crystallization, per 1 g of the above ethylene-propylene copolymer component. The heat of crystallization is larger than 10 J, the propylene block copolymer of the present invention may be poor in its impact resistance.

The above ethylene-propylene copolymer component has an intrinsic viscosity of preferably 0.1 to 10 dl/g, more preferably 1 to 8 dl/g, and particularly preferably 2 to 6 dl/g, measured at 135° C. in TETRALINE (tetrahydronaphthalene). When the intrinsic viscosity is within the above range, the propylene block copolymer of the present invention is particularly excellent in its impact resistance.

The above ethylene-propylene copolymer component has a glass transition temperature (Tg) of −50° C. or lower measured according to DSC. When the Tg is higher than −50° C., the propylene block copolymer of the present invention may not be excellent in its low-temperature impact resistance.

Also, the above ethylene-propylene copolymer component has an ethylene-propylene binding moiety, and the ethylene-propylene binding moiety has an intensity ratio of a racemic peak to a meso peak of 0.01 to 0.7, preferably 0.03 to 0.6, and more preferably 0.05 to 0.5, measured according to a ¹³C-NMR spectrum. The meso peak and racemic peak of the ethylene-propylene binding moiety are assigned by a literature such as Macromolecules, vol. 17, page 1950 (1984), and Journal of Applied Polymer Science, vol. 56, page 1782 (1985), and two peaks observed at about 37.5 ppm and about 37.9 ppm are the meso peak, and two peaks observed at about 38.4 ppm and about 38.8 ppm are the racemic peak. The total peak strength of those two peaks observed at about 37.5 ppm and about 37.9 ppm is the above meso peak intensity, and the total peak strength of those two peaks observed at about 38.4 ppm and about 38.8 ppm is the above racemic peak intensity. When the above peak strength ratio is smaller than 0.01, or is larger than 0.7, the propylene block copolymer of the present invention may not be excellent in its low-temperature impact resistance.

The propylene block copolymer of the present invention can be produced by polymerizing starting monomers with a stereoregular catalyst such as a catalyst comprising a solid titanium catalyst component, an organometallic compound catalyst component, and an optional electron donor.

An example of the solid titanium catalyst component is a solid catalyst component containing a trivalent-titanium compound, which is obtained by reducing a titanium compound with an organomagnesium compound in the presence of an organosilicon compound, thereby obtaining a solid catalyst component precursor having an average particle diameter of 25 μm or more, and then contacting the solid catalyst component precursor, a halogenating compound (for example, titanium tetrachloride) and an electron donor (for example, an ether compound, or a mixture of an ether compound with an ester compound), with one another.

More specifically, the above solid catalyst component is preferably a solid catalyst component obtained by contacting the following components (a), (b) and (c) with one another:

(a) a solid catalyst component precursor having an average particle diameter of 25 μm or more, which is obtained by reducing a titanium compound represented by the following general formula [I] with an organomagnesium compound in the presence of an organosilicon compound containing a Si—O bond,

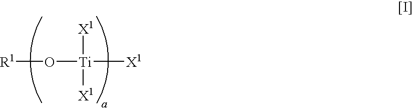

wherein a is a number of 1 to 20, R¹ is a hydrocarbyl group having 1 to 20 carbon atoms, and X¹ is independently of one another a halogen atom or a hydrocarbyloxy group having 1 to 20 carbon atoms;

(b) a halogenating compound; and

(c) an electron donor.

Examples of the organometallic compound catalyst component are organoaluminum compounds containing one or more Al-carbon bonds in their molecules, and preferred are trialkylaluminums, mixtures of trialkylaluminums with dialkylaluminum halides, or alkylalumoxanes. Among them, particularly preferred are trialkylaluminums, and specific examples thereof are triethylaluminum and triisobutylaluminum.

Examples of the electron donor compound are oxygen-containing compounds, nitrogen-containing compounds, phosphorus-containing compounds and sulfur-containing compounds. Among them, preferred are oxygen-containing compounds or nitrogen-containing compounds, and more preferred are oxygen-containing compounds. Among them, particularly preferred are alkoxysilicons or ethers.

As the alkoxysilicons, preferably used are alkoxysilicon compounds represented by the general formula, R²ᵣSi(OR³)₄₋ᵣ, wherein R² is independently of one another a hydrocarbyl group having 1 to 20 carbon atoms, a hydrogen atom, or a hetero atom-containing substituent; R³ is independently of one another a hydrocarbyl group having 1 to 20 carbon atoms; and r is a number satisfying 0≦r≦4.

Specific examples of the above alkoxysilicon compounds are di-tert-butyldimethoxysilane, tert-butylmethyldimethoxysilane, tert-butylethyldimethoxysilane, tert-butyl-n-propyldimethoxysilane, tert-butyl-n-butyldimethoxysilane, tert-amylmethyldimethoxysilane, tert-amylethyldimethoxysilane, tert-amyl-n-propyldimethoxysilane, tert-amyl-n-butyldimethoxysilane, isobutylisopropyldimethoxysilane, tert-butylisopropyldimethoxysilane, dicyclobutyldimethoxysilane, cyclobutylisopropyldimethoxysilane, cyclobutylisobutyldimethoxysilane, cyclobutyl-tert-butyldimethoxysilane, dicyclopentyldimethoxysilane, cyclopentylisopropyldimethoxysilane, cyclopentylisobutyldimethoxysilane, cyclopentyl-tert-butyldimethoxysilane, dicylohexyldimethoxysilane, cyclohexylmethyldimethoxysilane, cyclohexylethyldimethoxysilane, cyclohexylisopropyldimethoxysilane, cyclohexylisobutyldimethoxysilane, cyclohexyl-tert-butyldimethoxysilane, cyclohexylcyclopentyldimethoxysilane, cyclohexylphenyldimethoxysilane, diphenyldimethoxysilane, phenylmethyldimethoxysilane, phenylisopropyldimethoxysilane, phenylisobutyldimethoxysilane, phenyl-tert-butyldimethoxysilane, phenylcyclopentyldimethoxysilane, diisopropyldiethoxysilane, diisobutyldiethoxysilane, di-tert-butyldiethoxysilane, tert-butylmethyldiethoxysilane, tert-butylethyldiethoxysilane, tert-butyl-n-propyldiethoxysilane, tert-butyl-n-butyldiethoxysilane, tert-amylmethyldiethoxysilane, tert-amylethyldiethoxysilane, tert-amyl-n-propyldiethoxysilane, tert-amyl-n-butyldiethoxysilane, dicyclopentyldiethoxysilane, dicyclohexyldiethoxysilane, cyclohexylmethyldiethoxysilane, cyclohexylethyldiethoxysilane, dimethylaminotriethoxysilane, diethylaminotriethoxysilane, diethylaminotrimethoxysilane, diethylaminotri-n-propoxysilane, di-n-propylaminotriethoxysilane, methyl-n-propylaminotriethoxysilane, tert-butylaminotriethoxysilane, ethyl-n-propylaminotriethoxysilane, ethylisopropylaminotriethoxysilane, and methylethylaminotriethoxysilane.

The propylene block copolymer of the present invention is produced in the presence of the above catalyst for producing the propylene block copolymer, and is produced according to the following steps 1 and 2 using the above catalyst for producing the propylene block copolymer.

Polymerization step 1: polymerizing propylene only, thereby forming a propylene homopolymer, or copolymerizing propylene with one or more olefins selected from the group consisting of ethylene and α-olefins having 4 to 18 carbon atoms, thereby forming a propylene copolymer, wherein the above copolymerization is carried out such that the above propylene copolymer contains polymerization units of the above olefins in an amount of 10% by weight or smaller, and preferably 5% by weight or smaller.

Polymerization step 2: copolymerizing propylene with ethylene in the presence of the propylene homopolymer or the propylene copolymer obtained in the above polymerization step 1, thereby forming an ethylene-propylene copolymer, to produce a propylene block copolymer.

The propylene block copolymer of the present invention is produced by adding a halogen-containing organoaluminum compound and a cyclic organo-nitrogen compound to the polymerization system during the polymerization step 2, or between the polymerization steps 1 and 2.

In order to satisfy all the requirements (II) to (V), it is necessary to add the above both compounds during the polymerization step 2, or between the polymerization steps 1 and 2. In case of adding none of the above both compounds, or adding either one compound thereof, the propylene block copolymer of the present invention cannot be obtained.

The above halogen-containing organoaluminum compound contains one or more Al-carbon bonds and one or more Al-halogen bonds in its molecule. Typical compounds are those represented by the following general formula:

R⁴ₐAlX²_{b}Y¹_{c}

wherein R⁴ is independently of each other a hydrocarbyl group having 1 to 20 carbon atoms; X² is independently of each other a halogen atom; Y¹ is independently of each other a hydrogen atom or an alkoxy group; a and b are a number satisfying 1≦a≦2; c is a number satisfying 0≦c≦1; and a+b+c=3.

Specific examples of the halogen-containing organoaluminum compound are dialkylaluminum halides such as dimethylaluminum chloride, diethylaluminum chloride, diisobutylaluminum chloride, and diethylaluminum iodide; alkylaluminum dihalides such as methylaluminum dichloride, ethylaluminum dichloride, isobutylaluminum dichloride, and ethylaluminum diiodide; and mixtures of trialkylaluminums with dialkylaluminum halides such as a mixture of triethylaluminum with diethylaluminum chloride.

As the above cyclic organo-nitrogen compound, preferably used are 3 to 8-membered cyclic organo-nitrogen compounds. Examples of those compounds are pyridine, pyridine derivatives, piperidine, piperidine derivatives, pyrrolidine, and pyrrolidine derivatives. More preferred are aromatic nitrogen-containing heterocyclic compounds whose nitrogen-containing heterocyclic part has a 6-membered structure, and further preferred are 6-membered aromatic heterocyclic compounds having substituents at its 2- and 6-positions.

Examples of those compounds are pyridine, piperidine, pyrrolidine, 2,6-dimethoxypyridine, 2,6-diethoxypyridine, 2,6-dipropoxypyridine, 2,6-diisopropoxypyridine, 2,6-di-n-butoxypyridine, 2,6-di-tert-butoxypyridine, 2,6-dibenzyloxypyridine, 2,4,6-tribenzyloxypyridine, 2,6-diphenoxypyridine, 2,6-diacetoxypyridine, 2,6-difluoropyridine, 2,4,6-trifluoropyridine, 2,6-dichloropyridine, 2,4,6-trichloropyridine, 2,6-dimethylpyridine(2,6-lutidine), 2,6-diethylpyridine, 2,6-dipropylpyridine, and 2,6-diisopropylpyridine.

Examples of a polymerization method applicable to production of the propylene block copolymer of the present invention are a solvent polymerization method, a slurry polymerization method, and a gas-phase polymerization method, and either a continuous polymerization method or a batchwise polymerization method is applicable.

Examples of the solvent used for the above solvent polymerization method or slurry polymerization method are aliphatic hydrocarbons such as butane, pentane, hexane, heptane and octane; aromatic hydrocarbons such as benzene and toluene; and halogenated hydrocarbons such as methylene dichloride.

Polymerization temperature is usually −50 to 170° C., and preferably −20 to 140° C. Polymerization pressure is usually atmospheric pressure to 6 MPa. Polymerization time is generally determined suitably according to a type of a target polymer or a reaction apparatus, and is usually 1 minute to 20 hours.

A ratio by weight of the propylene polymer component to the ethylene-propylene copolymer component can be controlled by changing a polymerization time for forming the propylene polymer component and the ethylene-propylene copolymer component, respectively.

The ethylene-propylene copolymer component can be controlled in its composition (proportion of polymerized monomers) by changing a gas composition of a mixed gas of propylene and ethylene used for forming the ethylene-propylene copolymer component.

Also, in order to regulate a molecular weight of the propylene block copolymer of the present invention, a chain-transfer agent such as hydrogen may be added to a polymerization system.

### EXAMPLE

The present invention is explained with the following Examples and Comparative Examples. Respective physical property values in Examples and Comparative Examples were measured according to the following methods.

(1) Intrinsic Viscosity ([ηn], Unit: dl/g)

It was obtained according to a method comprising the steps of:
measuring respective reduced viscosities of TETRALINE (tetrahydronaphthalene) solutions having concentrations of 0.1, 0.2 and 0.5 g/dl, at 135° C. with an Ubbellohde viscometer; and
calculating an intrinsic viscosity according to a method described in “Kobunshi yoeki, Kobunshi jikkengaku 11” (published by Kyoritsu Shuppan Co. Ltd. in 1982), section 491, namely, by plotting those reduced viscosities for those concentrations, and then extrapolating the concentration to zero.

### (1-1) Intrinsic Viscosity of Propylene-Ethylene Block Copolymer

(1-1a) Intrinsic viscosity of Propylene Polymer Component: [η]P

An intrinsic viscosity [η]P of a propylene homopolymer or a propylene copolymer obtained by copolymerizing propylene with one or more olefins selected from the group consisting of ethylene and α-olefins having 4 to 18 carbon atoms was obtained according to a procedure comprising the steps of taking a polymer powder out of a polymerization reactor after polymerization for forming a propylene polymer component, and measuring according to the method mentioned in the above (1). (1-1b) Intrinsic viscosity of ethylene-propylene copolymer component: [η]EP

An intrinsic viscosity [η]EP of an ethylene-propylene copolymer component was obtained according to a procedure comprising the steps of measuring each of an intrinsic viscosity [η]P of a propylene polymer component and an intrinsic viscosity [η]T of a propylene block copolymer in its entirety according to the method mentioned in the above (1), and calculating the following formula using X, wherein X is a ratio by weight of the ethylene-propylene copolymer component to the propylene block copolymer in its entirety, and was obtained according to the measurement method mentioned in the following (2):

[η]EP=[η]T/X−(1/X−1)[η]P

wherein [η]P is an intrinsic viscosity of propylene polymer component, and [η]T is an intrinsic viscosity of a propylene block copolymer in its entirety.
(2) Ratio by weight (X, unit: % by weight) of ethylene-propylene copolymer component to propylene block copolymer in its entirety, and ethylene amount (C₂′, unit: % by weight) contained in ethylene-propylene copolymer component in propylene block copolymer

They were obtained from a ¹³C-NMR spectrum measured under the following conditions according to descriptions in Macromolecules, 15, 1150-1152 (1982) by Kakugo, et al., wherein a sample for the ¹³C-NMR measurement was prepared by dissolving homogeneously about 200 mg of a propylene block copolymer in 3 mL of o-dichlorobenzene using a 10 mm-Ψ test tube:
measurement temperature: 135° C.,
pulse repetition time: 10 seconds,
pulse width: 450, and
cumulated number: 2,500.
   (3) Intensity ratio of racemic peak to meso peak in ethylene-propylene binding moiety contained in propylene-ethylene copolymer component

It was obtained by calculating a ratio of the total peak strength (racemic peak intensity) of two peaks observed at about 38.4 ppm and about 38.8 ppm, to the total peak strength (meso peak intensity) of two peaks observed at about 37.5 ppm and about 37.9 ppm, those peaks being contained in a ¹³C-NMR spectrum measured according to the method mentioned in the above (2).

### (4) Glass Transition Temperature (Tg, Unit: ° C.)

It was measured with a differential scanning calorimeter DSC Q100 manufactured by TA Instruments Inc. according to a method comprising the steps of:
melting about 10 mg of a propylene block copolymer at 200° C. under a nitrogen atmosphere;
keeping at 200° C. for 5 minutes;
cooling down to −90° C. at a rate of 10° C./minute; and heating at a rate of 10° C./minute, thereby obtaining an endothermic curve, Tg being measured from the curve according to JIS K7121.

### (5) Melting Temperature (Tm, Unit: ° C.) of Propylene Polymer Component

Among endothermic peaks measured by the DSC measurement in the above (4), a peak temperature of a peak appearing at 150 to 170° C. was assigned to Tm of a propylene polymer component.

### (6) Crystallization Calorie of Ethylene-Propylene Copolymer Component (Unit: J)

It was obtained by dividing heat of crystallization of a crystallization peak by X, the crystallization peak being a peak appearing at 90 to 105° C. among peaks observed in the cooling step of the DSC measurement in the above (4), and X being a ratio defined in the above (2).

### Example 1

A stainless steel autoclave having a 3-liter inner volume and equipped with a stirrer was dried under a reduced pressure, and was purged with an argon gas. The autoclave was cooled, and then was evacuated. There were contacted with one another 4.4 mmol of triethylaluminum, 0.44 mmol of tert-butyl-n-propyldimethoxysilane, and 11.7 mg of a solid catalyst component described in JP 2004-182981A, Example 1 (2) in heptane contained in a glass charger, and the resultant mixture was put all together in the above autoclave. Further, 780 g of liquid propylene and 1 MPa of hydrogen were fed to the autoclave in this order, and then its temperature was raised up to 80° C., thereby initiating polymerization. After 10 minutes from the initiation, unreacted propylene was purged out of the polymerization system. The inside of the autoclave was substituted with argon, and then a small amount of a polymer was sampled. The polymer was found to have an intrinsic viscosity [η]P of 1.05 dl/g.

Next, the above 3-liter autoclave was depressurized. There were mixed with each other 1.0 mmol of diethylaluminum chloride and 20 mL of heptane in a glass charger, and the resultant mixture was put in the above autoclave. The mixture was stirred for 30 minutes. Then, there were mixed with each other 0.88 mmol of 2,6-lutidine and 20 mL of heptane in a glass charger, and the resultant mixture was put in the above autoclave. The mixture was stirred for 30 minutes.

Next, a 30-liter inner volume stainless steel autoclave equipped with a stirrer, and connected to the above 3-liter autoclave was evacuated. A mixed gas of 440 g of propylene with 230 g of ethylene was heated up to 80° C., and was fed continuously to the above 30-liter autoclave, thereby polymerizing under a polymerization pressure of 0.8 MPa for 5 hours. The polymerization was terminated by purging the gas contained in the autoclave, and the resultant polymer was dried at 60° C. for 5 hours under a reduced pressure, thereby obtaining 240 g of polymer powder. The obtained polymer was found to have an intrinsic viscosity [η]T of 1.68 dl/g. The polymer was found to contain 36.9% by weight of an ethylene-propylene copolymer component (referred to as “EP component” hereinafter), thereby finding an intrinsic viscosity [η]EP of the EP component to be 2.76 dl/g. Tm of a propylene homopolymer, an ethylene content in the EP component, Tg of the EP component, and heat of crystallization per 1 g of the EP component were found to be 161.3° C., 52% by weight, −51.1° C., and 9.1 J, respectively. Polymerization results and analytical results of the obtained polymer are shown in Tables 1 and 2, respectively.

### Example 2

The polymerization in Example 1 was repeated except that 10.6 mg of the solid catalyst component was used, and 1.0 mmol of ethylaluminum dichloride was used in place of diethylaluminum chloride. Polymerization results and analytical results of the obtained polymer are shown in Tables 1 and 2, respectively.

### Comparative Example 1

The polymerization in Example 1 was repeated except that 13.3 mg of the solid catalyst component was used, and diethylaluminum chloride and 2,6-lutidine were not used. Polymerization results and analytical results of the obtained polymer are shown in Tables 1 and 2, respectively.

### Comparative Example 2

The polymerization in Example 1 was repeated except that 9.9 mg of the solid catalyst component was used, and diethylaluminum chloride was not used. Polymerization results and analytical results of the obtained polymer are shown in Tables 1 and 2, respectively.

### Comparative Example 3

The polymerization in Example 1 was repeated except that 10.7 mg of the solid catalyst component was used, and 2,6-lutidine was not used. Polymerization results and analytical results of the obtained polymer are shown in Tables 1 and 2, respectively.

### Comparative Example 4

The polymerization in Comparative Example 3 was repeated except that 10.8 mg of the solid catalyst component was used, and 1.0 mmol of ethylaluminum dichloride was used in place of diethylaluminum chloride. Polymerization results and analytical results of the obtained polymer are shown in Tables 1 and 2, respectively.

### Comparative Example 5

The polymerization in Example 1 was repeated except that 11.0 mg of the solid catalyst component was used, and 1.0 mmol of triethylaluminum was used in place of diethylaluminum chloride. Polymerization results and analytical results of the obtained polymer are shown in Tables 1 and 2, respectively.

### Example 3

The polymerization in Example 2 was repeated except that 9.1 mg of the solid catalyst component was used, the amount of propylene and ethylene fed to the 30-liter inner volume stainless steel autoclave was changed to 580 g and 220 g, respectively, and the ethylene-propylene copolymer component was produced under a polymerization pressure of 1.0 MPa. Polymerization results and analytical results of the obtained polymer are shown in Tables 1 and 2, respectively.

### Example 4

The polymerization in Example 3 was repeated except that 9.9 mg of the solid catalyst component was used, and 0.5 mmol of ethylaluminum dichloride was used. Polymerization results and analytical results of the obtained polymer are shown in Tables 1 and 2, respectively.

### Example 5

The polymerization in Example 1 was repeated except that 7.3 mg of the solid catalyst component was used, 1.0 mmol of ethylaluminum sesquichloride was used in place of ethylaluminum chloride, and the amount of propylene and ethylene fed to the 30-liter inner volume stainless steel autoclave was changed to 580 g and 220 g, respectively. Polymerization results and analytical results of the obtained polymer are shown in Tables 1 and 2, respectively.

### Example 6

The polymerization in Example 5 was repeated except that 6.9 mg of the solid catalyst component was used, and 1.0 mmol of dimethylaluminum chloride was used in place of ethylaluminum sesquichloride. Polymerization results and analytical results of the obtained polymer are shown in Tables 1 and 2, respectively.

### INDUSTRIAL APPLICABILITY

The propylene block copolymer of the present invention can provide a molded article excellent in its stiffness and impact resistance, particularly in its low-temperature impact resistance.

TABLE 1

| | Example | | | | | |
|---|---|---|---|---|---|---|
| | 1 | 2 | 3 | 4 | 5 | 6 |
| Cyclic organo-nitrogen compound | | | | | | |
| (2,6-lutidine) | | | | | | |
| Additive amount (mmol) | 0.88 | 0.88 | 0.88 | 0.88 | 0.88 | 0.88 |
| Halogen-containing organoaluminum | | | | | | |
| compound | | | | | | |
| Kind | Et₂AlCl | EtAlCl₂ | EtAlCl₂ | EtAlCl₂ | Et₃Al₂Cl₃ | Me₂AlCl |
| Additive amount (mmol) | 1 | 1 | 1 | 0.5 | 1 | 1 |
| Polymerization activity | | | | | | |
| g-polymer/g-solid catalyst | 20,500 | 17,000 | 21,500 | 33,400 | 20,800 | 24,200 |

| | Comparative Example | | | | |
|---|---|---|---|---|---|
| | 1 | 2 | 3 | 4 | 5 |
| Cyclic organo-nitrogen compound | | | | | |
| (2,6-lutidine) | | | | | |
| Additive amount (mmol) | — | 0.88 | — | — | 0.88 |
| Halogen-containing organoaluminum compound | | | | | |
| Kind | — | — | Et₂AlCl | EtAlCl₂ | Et₃Al |
| Additive amount (mmol) | — | — | 1 | 1 | 1 |
| Polymerization activity | | | | | |
| g-polymer/g-solid catalyst | 24,100 | 24,300 | 20,500 | 18,800 | 24,600 |

TABLE 2

| | | Example | | | | | |
|---|---|---|---|---|---|---|---|
| | | 1 | 2 | 3 | 4 | 5 | 6 |
| Crystalline polypropylene part | | | | | | | |
| [η]P | dl/g | 1.05 | 0.99 | 1.00 | 1.00 | 1.06 | 1.03 |
| Tm | ° C. | 161.3 | 162.3 | 161.9 | 160.6 | 161.7 | 162.3 |
| Ethylene-propylene copolymer part | | | | | | | |
| Content | wt % | 36.9 | 26.3 | 24.6 | 24.6 | 19.6 | 27.7 |
| C₂′ | wt % | 51.5 | 57.7 | 50.1 | 50.1 | 55.1 | 48.9 |
| C₃′ | wt % | 48.5 | 42.3 | 49.9 | 49.9 | 44.9 | 51.1 |
| Heat of Tc | J/g-EP | 9.1 | 5.3 | 8.8 | 7.1 | 6.9 | 5.2 |
| Tg | ° C. | −51.1 | −56.3 | −53.7 | −52.6 | −54.2 | −53.4 |
| [η]EP | dl/g | 2.76 | 3.12 | 2.99 | 2.99 | 2.79 | 2.40 |
| Propylene-ethylene block copolymer | | | | | | | |
| [η]t | dl/g | 1.68 | 1.55 | 1.49 | 1.49 | 1.40 | 1.41 |

| | | | | | | |
|---|---|---|---|---|---|---|
| Racemic-meso strength ratio | 0.13 | 0.10 | 0.12 | 0.14 | 0.14 | 0.12 |

| | | Comparative Example | | | | |
|---|---|---|---|---|---|---|
| | | 1 | 2 | 3 | 4 | 5 |
| Crystalline polypropylene part | | | | | | |
| [η]P | dl/g | 1.04 | 1.03 | 1.05 | 1.06 | 1.01 |
| Tm | ° C. | 162.3 | 163.1 | 162.9 | 162.7 | 161.4 |
| Ethylene-propylene copolymer part | | | | | | |
| Content | wt % | 37.8 | 34.8 | 37.3 | 40.1 | 34.0 |
| C₂′ | wt % | 40.8 | 45.6 | 48.6 | 49.1 | 44.7 |
| C₃′ | wt % | 59.2 | 54.4 | 51.4 | 50.9 | 55.3 |
| Heat of Tc | J/g-EP | 3.9 | 6.1 | 4.9 | 6.8 | 5.7 |
| Tg | ° C. | −43.0 | −43.2 | −45.8 | −45.4 | −44.4 |
| [η]EP | dl/g | 4.00 | 4.25 | 3.30 | 3.78 | 3.89 |
| Propylene-ethylene block copolymer | | | | | | |
| [η]t | dl/g | 2.16 | 2.15 | 1.89 | 2.15 | 1.99 |

| | | | | | |
|---|---|---|---|---|---|
| Racemic-meso strength ratio | 0 | 0 | 0 | 0 | 0 |

1. A propylene block copolymer comprising 60 to 85% by weight of a propylene polymer component and 15 to 40% by weight of an ethylene-propylene copolymer component, and satisfying the following requirements (I) to (V):
(I) the above propylene polymer component has a melting temperature of 160° C. or higher measured according to DSC;
(II) the above ethylene-propylene copolymer component has an ethylene content of 40 to 60% by weight measured according to a ¹³C-NMR spectrum;
(III) the above ethylene-propylene copolymer component has a crystallization peak between 90 to 105° C. in its DSC measurement, and the above crystallization peak is 2 to 10 J in its heat of crystallization, per 1 g of the above ethylene-propylene copolymer component;
(IV) the above ethylene-propylene copolymer component has a glass transition temperature of −50° C. or lower measured according to DSC; and
(V) the above ethylene-propylene copolymer component has an ethylene-propylene binding moiety, and the ethylene-propylene binding moiety has an intensity ratio of a racemic peak to a meso peak of 0.01 to 0.7 measured according to a ¹³C-NMR spectrum.
